(19) United States
(12) Patent Application Publication
(10) Pub. No.: US 2025/0208582 A1
(43) Pub. Date: Jun. 26, 2025

(54) METHOD FOR DEPOSITING A VISIBLE LIGHT-ABSORBING COATING OVER A SUBSTRATE

(71) Applicant: The Swatch Group Research and Development Ltd, Marin (CH)

(72) Inventors: Nicolas FRANÇOIS, Neuchâtel (CH); Nathalie TERES, Bôle (CH)

(73) Assignee: The Swatch Group Research and Development Ltd, Marin (CH)

(21) Appl. No.: 18/945,903

(22) Filed: Nov. 13, 2024

(30) Foreign Application Priority Data
Dec. 20, 2023 (EP) 23218854.0

(51) Int. Cl. G04D 3/00

(52) U.S. Cl. CPC G04D 3/0092; G04D 3/0069

(57) ABSTRACT

A method (100) for depositing over a substrate (1) a coating (20) absorbing visible light for the formation of an item (10), such as a watch component, including: providing a substrate (1); depositing an underlayer (21) covering at least one portion of the substrate (1) by application of a first liquid mixture including a binder, a solvent and pigments having a d90 percentile of nanometric dimension, the underlayer (21) being formed by evaporation of said solvent; depositing a stack (25) of a plurality of layers (22, 23, 24) with different particle sizes between each layer n of the stack (25) by successive application of a plurality of liquid mixtures including a binder, a solvent and pigments with different particle sizes; each layer of the stack (25) being formed by evaporation of the solvent and each layer n at least partially covering a preceding layer n−1.

### CROSS-REFERENCE TO RELATED APPLICATION

This application claims priority to European Patent Application No. 23218854.0, filed on Dec. 20, 2023, the disclosures of which are incorporated by reference herein their entireties.

### TECHNICAL FIELD OF THE INVENTION

The field of the invention relates to the surface treatment of items, such as decorative items or watch components.

The invention relates more particularly to a method for depositing a decorative coating which has the optical characteristic of absorbing visible light.

The invention also relates to an item, for example a watch component, coated with such a decorative coating that absorbs visible light.

The invention has a particularly interesting application in the field of watchmaking, for the decoration of items or components used in timepieces, for example plates, bridges, trains, screws, oscillating weights, dials, indexes, appliques, aperture discs, hands or any other component of the movement or external casing of a timepiece.

### TECHNOLOGICAL BACKGROUND

There are coatings that absorb visible light and have a light absorption of over 99.8%.

We know in particular the Vantablack® coating based on carbon nanotubes oriented perpendicular to the surface of the substrate and pressed against each other. Such a coating confers a black colour with an absorption coefficient of 99.965% of visible light.

Nonetheless, carbon nanotube-based coatings are very expensive and present health risks, as these particles are known to be carcinogenic, mutagenic or reprotoxic.

Musou® acrylic paint, which is easier to use and apply, is also known and has an absorption of up to 99.4% of visible light and a lightness component L* close to 10. Nonetheless, this coating has the particularity of being very fragile and light contact with the coating can easily lead to peeling of the coating or a deterioration in its absorption. For example, it is very complicated to clean this type of coating without damaging its aesthetic appearance, if dust or fibres have been deposited. Such a paint is not easily applicable, for example, in the watchmaking industry.

As a result, there is a need to improve these visible-light-absorbing coatings, enabling them to be used on items that can be handled, like for example watch components, without risk to health and without the risk of the coating being damaged by simple contact or handling of the item.

### SUMMARY OF THE INVENTION

In this context, the invention aims to offer an item comprising a coating with very high light absorption while avoiding the use of carbon nanotubes and/or graphene particles.

To this end, the invention relates to a method for depositing over a substrate a coating absorbing visible light for the formation of an item, such as a watch component, said deposition method being characterised in that it comprises:
a first step of providing a substrate;
a second step of depositing an underlayer covering at least one portion of the substrate by application of a first liquid mixture comprising a binder, a solvent and pigments having a d90 percentile of nanometric dimension, the underlayer being formed by evaporation of said solvent;
a third step of depositing a stack of a plurality of layers with different particle sizes between each layer n of the stack by successive application of a plurality of liquid mixtures comprising a binder, a solvent and pigments with different particle sizes; each layer of the stack being formed by evaporation of the solvent and each layer n at least partially covering a preceding layer n−1.

According to the invention, one of the aims of the invention is to provide a method for depositing a decorative coating that absorbs visible light, is easy to implement and allows obtaining surface coatings with a lightness component L* of less than 20 on substrates of various kinds.

Preferably, the first liquid mixture forming the coating underlayer comprises between 5 and 10% by weight of pigments.

Preferably, the third step of depositing a stack of a plurality of layers is carried out by the successive application of a plurality of liquid mixtures, each liquid mixture for forming the plurality of layers of the stack comprising a binder, a solvent and pigments whose d90 percentile increases between each successive deposit of the layers forming the stack.

Preferably, each layer (n) of the plurality of layers of the stack has pigments whose size d90 percentile corresponds to n*k/10 μm, where k is a homothetic factor between the d90 percentile of the pigments of two consecutive layers of the stack.

Preferably, the third step of depositing a stack of a plurality of layers is carried out by the successive application of a plurality of liquid mixtures, each liquid mixture for forming the plurality of layers of the stack comprising a binder, a solvent and pigments whose size d90 percentile increases between each successive deposit of layers of the stack, and whose proportion by weight of pigments in each liquid mixture decreases as the d90 percentile of the pigments increases.

Preferably, the plurality of liquid mixtures for forming the plurality of layers of the stack comprises between 0.5 and 10% by weight of pigments.

Preferably, the third step of depositing a stack comprises a first sub-step of depositing a first stack layer from a liquid mixture comprising between 0.5 and 10% by weight of pigments in the mixture, the pigments having a d90 percentile corresponding to k/10 μm, with k the homothetic factor between the d90 percentile of the pigments of two consecutive layers of the stack.

Preferably, the liquid mixture for depositing the first layer of the stack comprises between 4 and 10% by weight of pigments, preferably between 4 and 8% by weight of pigments.

Preferably, the third step of depositing a stack comprises a second sub-step of depositing a second stack layer from a liquid mixture comprising between 0.5 and 10% by weight of pigments in the mixture, the pigments having a d90 percentile corresponding to 2k/10 μm, with k the homothetic factor between the d90 percentile of the pigments of two consecutive layers of the stack.

Preferably, the liquid mixture for depositing the second layer of the stack comprises between 1 and 4% by weight of pigments.

Preferably, the third step of depositing a stack comprises a third sub-step of depositing a third stack layer from a liquid mixture comprising between 0.5 and 10% by weight of pigments in the mixture, the pigments having a d90 percentile corresponding to 3k/10 μm, with k the homothetic factor between the d90 percentile of the pigments of two consecutive layers of the stack.

Preferably, the liquid mixture for depositing the third layer of the stack comprises between 0.5 and 4% by weight of pigments, preferably between 0.5 and 1% by weight of pigments.

Preferably, the underlayer and/or the plurality of layers of the stack are deposited by spraying, dipping, screen-printing, printing or pad printing.

Preferably, the first liquid mixture forming the underlayer of the coating and/or the plurality of liquid mixtures forming the plurality of layers of the stack are composed of a binder, a solvent, pigments, optionally a matting agent, glass beads and/or a dispersing agent.

Preferably, the binder is a polymer.

Preferably, the binder is an acrylic, an epoxy polymer or a polyurethane.

Preferably, the first liquid mixture forming the underlayer of the coating and/or the plurality of liquid mixtures forming the plurality of layers of the stack are coloured inks.

The invention also relates to an item comprising a substrate and a coating applied by the method according to the invention.

Such an item therefore has a light-absorbing surface coating with a lightness component L* of less than 20.

Preferably, the item is a watch component.

The invention also relates to a timepiece comprising such a watch component.

### BRIEF DESCRIPTION OF THE FIGURES

The aims, advantages and features of the present invention will become apparent upon reading the detailed description below with reference to the following figures:

FIG. 1 schematically illustrates a sectional view of an item, such as a watch component, comprising a substrate and a coating absorbing visible light according to the invention;

FIG. 2 illustrates the main successive steps of an example of a method for depositing a coating absorbing visible light over a substrate for making an item, such as a watch component, according to the invention;

FIG. 3 illustrates an embodiment of an item according to the invention.

### DETAILED DESCRIPTION OF THE INVENTION

In the present description, the colorimetric properties of the light-absorbing coating obtained according to the method for depositing a coating according to the invention are expressed using the CIE L*a*b* colorimetric space and measured according to the CIE 1976 standard on polished samples with a KONICA MINOLTA CM-3610-A spectrophotometer, with the following parameters: illumination source CIE D65 (daylight 6,500° K), 10° inclination, SCI measurements (comprising specular reflection), measurement area 4 mm in diameter.

A CIELAB colour space (in accordance with CIE standard no. 15, ISO 7724/1, DIN 5033 Teil 7, ASTM E-1164) has a lightness component L*, representative of the way in which the material reflects light, assimilated to lightness, with an a* component which is the green/red component and a b* component which is the blue/yellow component.

In the present application, the size of the particles and pigments is characterised in relation to the d90 value of a particle size distribution. In a particle size distribution, the use of the d90 percentile means that at least 90% of the particles or pigments in the used set of particles have a size below the given d90 value.

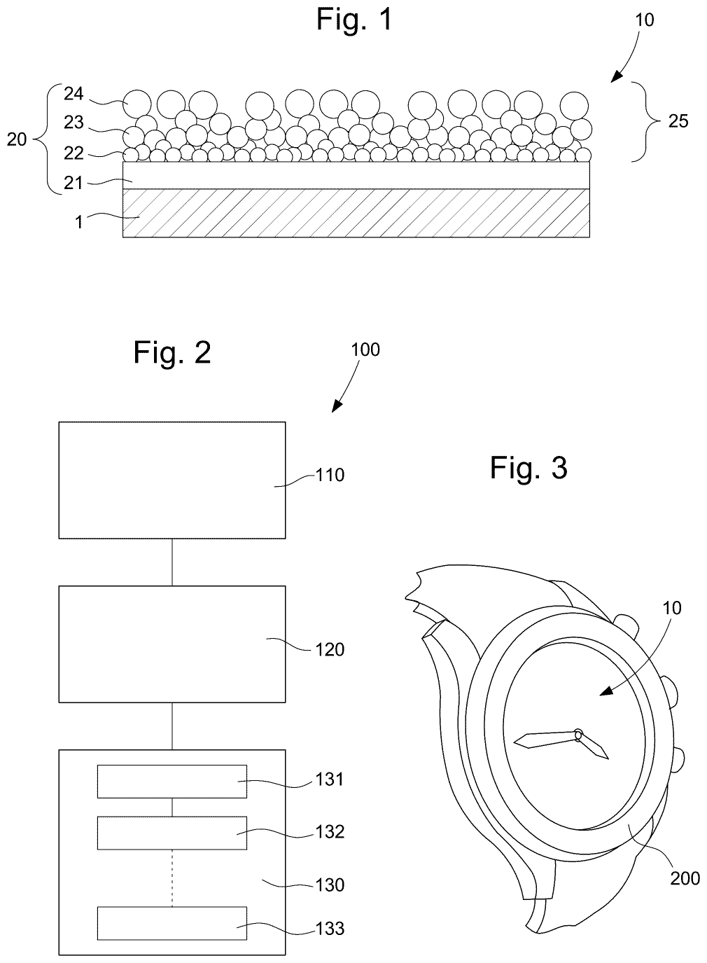

FIG. 1 schematically illustrates a sectional view of an item 10, such as a watch component, comprising a substrate 1 and a visible light-absorbing coating 20 covering at least one portion of the substrate 1 by means of the deposition method 100 according to the invention. Such a light-absorbing coating 20 according to the invention forms a multilayer structure composed of pigments with a grain size that varies between the layers, preferably increasing as the number of layers increases.

Preferably, the density of pigments between the different layers of the coating 20 is also variable, preferably decreasing as the number of layers increases.

The item 10 is, for example, a watch component, for example a plate, a bridge, a wheel, a screw, an oscillating weight, a dial, an index, an applique, an aperture disc, a hand or any other component or organ of a watch movement or of a component for the casing of a timepiece, to which it is desired to give an impression of deep and intense colour, without light reflection, with a lightness component L* of less than 20.

FIG. 3 illustrates a timepiece 200 comprising an item 10 according to the invention. In this embodiment, item 10 according to the invention is a dial.

The substrate 1 may be of any material, for example metal, polymer, ceramic or even composite.

Thanks to the method according to the invention, it is possible to obtain an item 10 with a coating 20 whose lightness component L* is less than 20 with various substrates. For comparison, a Physical Vapour Deposition (PVD) coating process does not allow having a coating with a lightness component L* of less than 20 due to the topology of the deposited layers. With PVD, the lightness component L* of a matt coating is between 25 and 30.

The particular multilayer structure of the light-absorbing coating 20 according to the invention allows avoiding reflection phenomena with the visible surface of the coating. The coating 20 also allows light to be diffused into the structure created by the differences in particle size of the pigments that make up the coating until it is trapped, so as to obtain maximum light absorption.

The coating 20 comprises an underlayer 21 forming a base layer, configured to cover the substrate 1, at least over a portion of the substrate 1.

Preferably, the underlayer 21 completely covers at least one surface of the substrate 1.

The underlayer 21 has a thickness sufficient to ensure that it is homogeneous and opaque and that the optical disturbance of the substrate 1 is no longer active. For example, the underlayer 21 has a thickness equal to or larger than 1 μm and smaller than 20 μm, and more preferably a thickness comprised between 5 μm and 10 μm.

Preferably, the underlayer 21 is formed by depositing over the substrate 1 a first liquid mixture comprising a binder, pigments and a solvent.

For example, the underlayer is formed by depositing a first liquid mixture comprising, by weight, 30 to 40% binder, 50 to 60% solvent and 5 to 10% pigments.

For example, the underlayer is formed by depositing a first liquid mixture made up, by weight, of 30% acrylic binder, 60% solvents and 10% Emperor® 1600 carbon black pigments.

Optionally, the first liquid mixture may also comprise a matting agent, for example a nanosilica, to further accentuate the intensity of the coating 20.

Optionally, the first liquid mixture may also comprise a dispersing agent to help suspend the pigments in the liquid mixture.

Preferably, the binder of the first liquid mixture forming the underlayer 21 is a polymer, for example an acrylic, an epoxy polymer or a polyurethane.

For example, the first liquid mixture is a coloured ink.

For example, the first liquid mixture is a black ink containing carbon black pigments.

For example, the first liquid mixture is applied to the substrate 1 by spraying, dipping, screen-printing, printing or pad printing.

Once the liquid mixture has been applied to the substrate 1, the solvent evaporates and the binder shrinks around the pigments, thereby creating the underlayer 21 of the coating 20.

Preferably, the pigments in the underlayer 21 have a d90 percentile of nanometric dimension, for example between 20 and 120 nm, preferably smaller than 100 nm. In this way, the underlayer 21 is a homogeneous layer with low roughness.

The underlayer 21 is covered by a stack 25 of several layers 22, 23, 24 superimposed on one another, each layer of the stack 25 having pigments whose d90 percentile is different from the size of the pigments in the layer it covers.

Preferably, the stack 25 has pigments distributed according to a d90 percentile that increases from the substrate towards the surface of the coating 20. In this way, each layer of the stack 25 has pigments with a d90 percentile larger than the d90 percentile of the pigments in the layer it covers.

Preferably, each layer n of the stack 25 has pigments with a d90 percentile equivalent to n*k/10 μm, where k is a homothetic factor between the d90 percentile of the pigments of the layer (n−1) previously deposited and the d90 percentile of the pigments of the layer n to be deposited, i.e. between two consecutive layers of the stack 25.

Preferably the homothetic factor is between 5 and 1,000.

In the embodiment shown in FIG. 1, the stack 25 comprises three layers 22, 23, 24 deposited successively. Of course, the stack 25 may comprise at least two successive layers or more than three successive layers to form the particular structure of the stack 25 covering the underlayer 21.

The first layer 22 of the stack 25 comprises pigments whose d90 percentile is higher in size than the d90 percentile of the pigments in the underlayer 21, for example of micrometric size and smaller than 20 μm, preferably in the range of 15 μm.

The second layer 23 of the stack 25 at least partially covering the first layer 22 of the stack 25 comprises pigments whose d90 percentile is, for example, in the range of 80 μm. The third layer 24 of the stack 25 at least partially covering the second layer 23 of the stack 25 comprises pigments whose d90 percentile is, for example, in the range of 250 μm.

Each layer 22, 23, 24 is formed respectively by successive deposition of a liquid mixture comprising a binder, pigments and a solvent, the d90 percentile of the pigments in the different liquid mixtures varying according to the aforementioned ratio to form the different layers with increasing granulometry, so as to increase the roughness of each deposited layer compared with the previous layer.

After each mixture has been applied by spraying, dipping, screen-printing, printing or pad printing, the solvent evaporates to allow polymerisation and shrinkage of the binder around the pigments, thereby forming a solid layer at least partially covering the previous layer or underlayer 21, the new layer having a roughness greater than the previous layer.

Preferably, the binder, the nature of the pigments and the solvent used to form the liquid mixtures for depositing the various layers 22, 23, 24 of the stack 25 are identical.

Optionally, the liquid mixtures for forming the stack 25 may comprise a matting agent, for example a nanosilica, to further accentuate the intensity of the stack 25 and more generally of the coating 20.

Optionally, the liquid mixtures used to form the stack 25 may comprise a dispersing agent to help suspend the pigments in the first liquid mixture.

Optionally, the liquid mixtures for forming the stack 25 may comprise glass beads to further increase the roughness of the stack. Preferably, the glass beads are used in the last layer of the stack 25.

Preferably, the binder of the liquid mixtures forming the stack 25 is a polymer, for example an acrylic, an epoxy polymer or a polyurethane.

For example, the liquid mixtures forming the stack 25 are coloured inks.

Preferably, the binder and solvent used to form the layers of the stack 25 are identical to those used to make the underlayer 21. The pigments used to form the layers of the stack 25 may be identical to or different from the pigments used to make the underlayer 21.

Preferably, the proportion of pigments in the liquid mixtures forming the different layers 22, 23, 24 of the stack 25 is between 0.5% and 10% by weight. Preferably, the proportion of pigments in the liquid mixture is higher when the d90 percentile of the pigments is smaller. Thus, the density of the pigments in the layers 22, 23, 24 of the stack 25 is lower and lower as the d90 percentile of the pigments increases.

For example, the first layer 22 of the stack 25 is made from a liquid mixture containing between 4 and 10% by weight of pigments, preferably between 4 and 8% by weight of pigments.

For example, the second layer 23 of the stack 25 is made from a liquid mixture containing between 1 and 4% by weight of pigments.

For example, the third layer 24 of the stack 25 is made from a liquid mixture comprising between 0.5 and 4% by weight of pigments, preferably between 0.5 and 1% by weight.

FIG. 2 illustrates the main steps in the method 100 for depositing a visible light absorbing coating 20 over a substrate 1 according to the invention.

The deposition method 100 according to the invention comprises a first step 110 of providing a substrate 1.

The deposition method 100 according to the invention comprises a second step 120 of depositing an underlayer 21, or base layer, covering at least one portion of the substrate 1. This second deposition step 120 is carried out by spraying, dipping, screen-printing, printing or pad printing of a first liquid mixture comprising a binder, a solvent and between 5 and 10% by weight of pigments with a d90 percentile of nanometric dimension, for example smaller than 100 nm.

This step 120 of depositing an underlayer 21 comprises a sub-step of evaporating the solvent from the liquid mixture applied to the substrate 1 so that the binder shrinks around the pigments to form the underlayer 21 of the coating 20.

The deposition method 100 also comprises a third step 130 of depositing a stack 25 of a plurality of superimposed layers 22, 23, 24 with different particle sizes between each layer of the stack 25.

This third step 130 comprises a first sub-step 131 of depositing a first layer 22 of the stack 25 from a liquid mixture comprising a binder, a solvent and between 0.5 and 10% by weight of pigments with a d90 percentile higher than 100 nm and equivalent to k/10 μm, with k the homothetic factor between the d90 percentile of the pigments of two consecutive layers of the stack 25.

Preferably, the liquid mixture for depositing the first layer 22 comprises between 4 and 10% by weight of pigments.

Preferably, the liquid mixture for depositing the first layer 22 comprises between 4 and 8% by weight of pigments.

This first sub-step 131 is carried out by spraying, dipping, screen- printing, printing or pad printing.

This first sub-step 131 comprises a step of evaporating the solvent from the liquid mixture applied to the underlayer 21 so that the binder shrinks around the pigments to form the first layer 22 of the coating 20, superimposed on the underlayer 21.

The third step 130 comprises a second sub-step 132 of depositing a second layer 23 of the stack 25 from a liquid mixture comprising a binder, a solvent and between 0.5 and 10% by weight of pigments with a d90 percentile equivalent to 2 k/10 μm, with k the homothetic factor between the d90 percentile of the pigments of the first layer 22 and the d90 percentile of the pigments of the second layer 23.

Preferably, the liquid mixture for depositing the second layer 23 comprises between 1 and 4% by weight of pigments.

This second sub-step 132 is carried out by spraying, dipping, screen-printing, printing or pad printing.

This second sub-step 132 comprises a step of evaporating the solvent from the liquid mixture applied to the first layer 22 so that the binder shrinks around the pigments to form the second layer 23 of the coating 20, superimposed on the first layer 22.

The third step 130 comprises a third sub-step 133 of depositing a third layer 24 of the stack 25 from a liquid mixture comprising a binder, a solvent and between 0.5 and 10% by weight of pigments with a d90 percentile equivalent to 3 k/10 μm, with k the homothetic factor between the d90 percentile of the pigments of the second layer 23 and the d90 percentile of the pigments of the third layer 24.

Preferably, the liquid mixture for depositing the third layer 24 comprises between 0.5 and 4% by weight of pigments.

Preferably, the liquid mixture for depositing the third layer 24 comprises between 0.5 and 1% by weight of pigments.

This third sub-step 133 is carried out by spraying, dipping, screen-printing, printing or pad printing.

This third sub-step 133 comprises a step of evaporating the solvent from the liquid mixture applied to the second layer 22 so that the binder shrinks around the pigments to form the third layer 24 of the coating 20, superimposed on the second layer 23.

Of course, the deposition method 100 may comprise other sub-steps of depositing additional layers depending on the number of layers desired in the stack 25 of the coating 20.

According to a first example of the invention, a brass substrate is used, for example to form a dial, to which a light-absorbing coating according to the invention is applied.

The brass substrate is, for example, 0.27 mm thick.

Underlayer 21 is applied to the brass substrate by dipping in an initial liquid mixture consisting of 2 g of polyurethane resin (Berlacryl), 0.5 g of Emperor 1600 carbon black pigments and 2.8 g of Berlaflex diluent. The layer is left to dry for 20 minutes to allow the diluent to evaporate.

The first layer 22 of the stack 25 is applied to the underlayer 21 by dipping in a second liquid mixture consisting of 2 g of polyurethane resin (Berlacryl), 0.3 g of Living Ink pigments and 3.5 g of Berlaflex diluent. The layer is left to dry for 20 minutes to allow the diluent to evaporate.

The second layer 23 of the stack 25 is applied to the first layer 22 by dipping in a third liquid mixture consisting of 2 g of polyurethane resin (Berlacryl), 0.2 g of Norit A ultra E153 pigments and 4 g of Berlaflex diluent. The layer is left to dry for 20 minutes to allow the diluent to evaporate.

The third layer 24 of the stack 25 is applied to the second layer 23 by dipping in a fourth liquid mixture consisting of 2 g of polyurethane resin (Berlacryl), 0.2 g of Norit SX super E153 carbon pigments, 1.5 g of 90-150 μm glass beads and 4 g of Berlaflex diluent. The layer is left to dry for 20 minutes to allow the diluent to evaporate.

With such a coating, the result is a brass dial with a black surface coating and a lightness component L* of 15.9.

1. A method of depositing over a substrate a coating absorbing visible light for the formation of an item, such as a watch component, wherein said deposition method comprises:
a first step of providing a substrate;
a second step of depositing an underlayer covering at least one portion of the substrate by application of a first liquid mixture comprising a binder, a solvent and pigments having a whose d90 percentile of nanometric dimension, the underlayer being formed by evaporation of said solvent; and
a third step of depositing a stack of a plurality of layers with different particle sizes between each layer n of the stack by successive application of a plurality of liquid mixtures comprising a binder, a solvent and pigments with different particle sizes; each layer of the stack being formed by evaporation of the solvent and each layer n at least partially covering a preceding layer n−1.

2. The method for depositing over a substrate a coating absorbing visible light for the formation of an item, according to claim 1, wherein said first liquid mixture forming the underlayer of the coating comprises between 5 and 10% by weight of pigments.

3. The method for depositing over a substrate a coating absorbing visible light for the formation of an item, according to claim 1, wherein said third step of depositing a stack of a plurality of layers is carried out by the successive application of a plurality of liquid mixtures, each liquid mixture for forming the plurality of layers of the stack comprising a binder, a solvent and pigments whose d90 percentile increases between each successive deposition of the layers forming the stack.

4. The method for depositing over a substrate a coating absorbing visible light for the formation of an item, according to claim 1, wherein each layer n of the plurality of layers of the stack has pigments whose d90 percentile corresponds to n*k/10 μm, where k is a homothetic factor between the d90 percentile of the pigments of two consecutive layers of the stack.

5. The method for depositing over a substrate a coating absorbing visible light for the formation of an item, according to claim 1, wherein said third step of depositing a stack of a plurality of layers is carried out by the successive application of a plurality of liquid mixtures, each liquid mixture for forming the plurality of layers of the stack comprising a binder, a solvent and pigments whose d90 percentile increases between each successive deposition of layers of the stack, and whose proportion by weight of pigments in each liquid mixture decreases as the d90 percentile of the pigments increases.

6. The method for depositing over a substrate a coating absorbing visible light for the formation of an item, according to claim 5, wherein said plurality of liquid mixtures for the formation of the plurality of layers of the stack comprises between 0.5 and 10% by weight of pigments.

7. The method for depositing over a substrate a coating absorbing visible light for the formation of an item, according to claim 1, wherein said third step of depositing a stack comprises a first sub-step of depositing a first layer of the stack from a liquid mixture comprising between 0.5 and 10% by weight of pigments in the mixture, the pigments having a d90 percentile corresponding to k/10 μm, with k the homothetic factor between the d90 percentile of the pigments of two consecutive layers of the stack.

8. The method for depositing over a substrate a coating absorbing visible light for the formation of an item, according to claim 7, wherein the liquid mixture for depositing the first layer of the stack comprises between 4 and 10% by weight of pigments.

9. The method for depositing over a substrate a coating absorbing visible light for the formation of an item, according to claim 1, wherein said third step of depositing a stack comprises a second sub-step of depositing a second layer of the stack from a liquid mixture comprising between 0.5 and 10% by weight of pigments in the mixture, the pigments having a d90 percentile corresponding to 2k/10 μm, with k the homothetic factor between the d90 percentile of the pigments of two consecutive layers of the stack.

10. The method for depositing over a substrate a coating absorbing visible light for the formation of an item, according to claim 9, wherein the liquid mixture for depositing the second layer of the stack comprises between 1 and 4% by weight of pigments.

11. The method for depositing over a substrate a coating absorbing visible light for the formation of an item, according to claim 1, wherein said third step of depositing a stack comprises a third sub-step of depositing a third layer of the stack from a liquid mixture comprising between 0.5 and 10% by weight of pigments in the mixture, the pigments having a d90 percentile corresponding to 3k/10 μm, with k the homothetic factor between the d90 percentile of the pigments of two consecutive layers of the stack.

12. The method for depositing over a substrate a coating absorbing visible light for the formation of an item, according to claim 11, wherein said liquid mixture for depositing the third layer of the stack comprises between 0.5 and 4% by weight of pigments.

13. The method for depositing over a substrate a coating absorbing visible light for the formation of an item, according to claim 1, wherein said underlayer and/or the plurality of layers of the stack are deposited by spraying, by dipping, by screen-printing, by printing or by pad printing.

14. The method for depositing over a substrate a coating absorbing visible light for the formation of an item, according to claim 1, wherein the first liquid mixture forming the underlayer of the coating and/or the plurality of liquid mixtures forming the plurality of layers of the stack are composed of a binder, a solvent, pigments, optionally a matting agent, glass beads and/or a dispersing agent.

15. The method for depositing over a substrate a coating absorbing visible light for the formation of an item, according to claim 14, wherein the binder is a polymer.

16. The method for depositing over a substrate a coating absorbing visible light for the formation of an item, according to claim 15, wherein the binder is an acrylic, an epoxy polymer or a polyurethane.

17. The method for depositing over a substrate a coating absorbing visible light for the formation of an item, according to claim 1, wherein the first liquid mixture forming the underlayer of the coating and/or the plurality of liquid mixtures forming the plurality of layers of the stack are coloured inks.

18. An item, comprising a substrate and a coating absorbing light deposited by the deposition method according to claim 1, wherein the coating having a lightness component L* of less than 20.

19. The item according to claim 18, wherein said item is a watch component.

20. A timepiece comprising a watch component according to claim 19.
